(19) United States
(12) Patent Application Publication
(10) Pub. No.: US 2026/0222377 A1
(43) Pub. Date: Jul. 30, 2026

(54) INFORMATION PROCESSING DEVICE

(71) Applicant: NTT DOCOMO, INC., Tokyo (JP)

(72) Inventors: Yukiko YOSHIKAWA, Tokyo (JP); Yuki KATSUMATA, Tokyo (JP)

(73) Assignee: NTT DOCOMO, INC., Tokyo (JP)

(21) Appl. No.: 19/145,010

(22) PCT Filed: Nov. 30, 2023
(86) PCT No.: PCT/JP2023/042980

§ 371 Date: Jul. 1, 2025

(30) Foreign Application Priority Data
Feb. 28, 2023 (JP) 2023-029461

(51) Int. Cl. H04L 51/222

(52) U.S. Cl. CPC H04L 51/222

(57) ABSTRACT

An information processing device (10) includes a selection unit (12) that, in an environment in which there are a first-type user group including a plurality of first-type users, who provide first attribute information (attribute information Xd) for regular service use and provide second attribute information (attribute information Xa) having a lower level of detail than the first attribute information in association with use of an individual application, and a second-type user group including a plurality of second-type users providing only the second attribute information, selects the first attribute information of the first-type user, which is a basis for inferring the first attribute information of a target user who is a target second-type user, according to a predetermined condition based on the first attribute information provided from the first-type user and the second attribute information provided from the first-type user and the second-type user.

### TECHNICAL FIELD

The present disclosure relates to an information processing device. In addition, the term “nudge” in the present disclosure means a wording expression that is derived based on attribute information of a user expected to correlate with the psychological characteristics (psychological biases and the like) of the user and is inferred to be suitable for encouraging the user to perform a certain action.

### BACKGROUND ART

In the related art, a technique is known that generates a message including a nudge corresponding to psychological characteristics of a user and pushes the message (see Patent Literature 1), and detailed attribute information of the user is required in order to obtain an appropriate nudge corresponding to the psychological characteristics of the user.

Meanwhile, the users to which the messages are to be pushed include users (for example, paid subscription members; hereinafter, referred to as “first-type users”) who regularly receive a certain service (including, for example, various services such as the use of a communication network service and the use of applications) and users (hereinafter, referred to as “second-type users”) who only receive a certain service on a temporary or one-off basis. When receiving the services, in general, while the second-type user among the users registers only simple attribute information, the first-type user registers detailed attribute information in addition to the simple attribute information. Therefore, for the first-type user, it seems relatively easy to obtain appropriate nudge information corresponding to the psychological characteristics of the first-type user, using both the registered detailed attribute information and simple attribute information.

### CITATION LIST

### Patent Literature

Patent Literature 1: Japanese Unexamined Patent Publication No. 2022-055712

### SUMMARY OF INVENTION

### Technical Problem

However, since the detailed attribute information is not registered for the second-type user, it is difficult to obtain appropriate nudge information corresponding to the psychological characteristics of the second-type user even though only the simple attribute information is used. As a solution to this problem, a method is considered that predicts the detailed attribute information from the simple attribute information of the second-type user, using a relationship between the simple attribute information and the detailed attribute information of the first-type user (for example, a learning model in which the simple attribute information is used as an explanatory variable and the detailed attribute information is used as a response variable). However, when the dimension of the level of detail of the simple attribute information and the detailed attribute information is considered, high-dimensional “detailed attribute information” is predicted from low-dimensional “simple attribute information”. As a result, the accuracy of the prediction is reduced, and it is not expected that the detailed attribute information of the second-type user will be appropriately acquired. For this reason, in order to obtain appropriate nudge information related to the second-type user on a similar basis to that for the first-type user, there is a strong demand for a new method that obtains appropriate basic information for inferring the detailed attribute information of the second-type user.

The present disclosure has been made to solve the above-mentioned problems, and an object of the present disclosure is to obtain appropriate basic information for inferring detailed attribute information related to a user whose detailed attribute information has not been registered.

### Solution to Problem

According to the present disclosure, there is provided an information processing device including a selection unit that, in an environment in which there are a first-type user group including a plurality of first-type users, who provide first attribute information for regular service use and provide second attribute information having a lower level of detail than the first attribute information in association with use of an individual application, and a second-type user group including a plurality of second-type users providing only the second attribute information, selects the first attribute information of the first-type user, which is a basis for inferring the first attribute information of a target user who is a target second-type user, according to a predetermined condition based on the first attribute information provided from the first-type user and the second attribute information provided from the first-type user and the second-type user.

In the information processing device, in the environment in which there are the first-type user group including the plurality of first-type users, who provide the first attribute information for regular service use and provide the second attribute information having a lower level of detail than the first attribute information in association with the use of the individual application, and the second-type user group including the plurality of second-type users providing only the second attribute information, the selection unit selects the first attribute information of the first-type user, which is the basis for inferring the first attribute information of the target user who is the target second-type user, according to the predetermined condition based on the first attribute information provided from the first-type user and the second attribute information provided from the first-type user and the second-type user. In addition, the first attribute information selected here may be information obtained from the first attribute information of one first-type user or may be information obtained from the first attribute information of a plurality of first-type users.

The information obtained in this way (the selected first attribute information) is used as the basis for inferring the first attribute information of the target user and is the first attribute information of one or more first-type users, that is, high-dimensional “detailed attribute information”. Therefore, it is possible to avoid inconvenience associated with the prediction of the high-dimensional “detailed attribute information” from the low-dimensional “simple attribute information” and thus to obtain appropriate basic information for inferring detailed attribute information (first attribute information) related to the target user whose detailed attribute information has not been registered.

### Advantageous Effects of Invention

According to the present disclosure, it is possible to obtain appropriate basic information for inferring detailed attribute information (first attribute information) related to the target user whose detailed attribute information has not been registered.

### BRIEF DESCRIPTION OF DRAWINGS

FIG. 1 is a functional block diagram showing a configuration of an information processing device according to an embodiment of the invention.

FIG. 2 is a flowchart showing a process executed by the information processing device.

FIG. 3 is a flowchart showing a process of generating a nudge for a target user.

FIG. 4 is a view showing setting of a distance calculation formula in an Xa space in which attribute information Xa is plotted.

FIG. 5 is a view supplementing content of FIG. 4.

FIG. 6 is a view showing clustering in the Xa space, selection of first-type users, and inference of attribute information Xd of the target user.

FIG. 7 is a view showing prediction of the number of times a message including a nudge is opened for each nudge.

FIG. 8 is a view showing push delivery of the message including the nudge.

FIG. 9 is a view showing Modification Example 1 in which weighting is performed in the prediction of the number of times the message is opened.

FIG. 10 is a view showing a process in Modification Example 2 in which a prediction result of the number of times the message is opened is fed back to the setting of the distance calculation formula in the Xa space.

FIG. 11 is a view showing the setting of the distance calculation formula in Modification Example 2.

FIG. 12 is a view showing an example of a hardware configuration of the information processing device.

### DESCRIPTION OF EMBODIMENTS

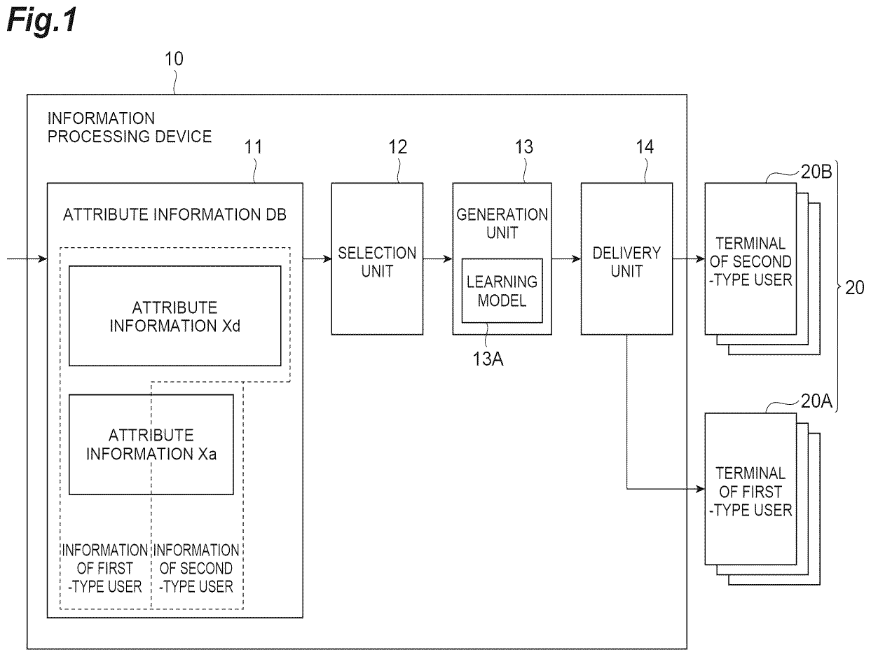

Hereinafter, an embodiment of an information processing device according to the present disclosure will be described with reference to the drawings. As shown in FIG. 1, an information processing device 10 includes an attribute information database (attribute information DB) 11, a selection unit 12, a generation unit 13, and a delivery unit 14. Hereinafter, functions of each unit will be outlined.

The attribute information DB 11 is a database for storing attribute information of various users. In this embodiment, an environment is assumed in which there are a first-type user group including a plurality of first-type users who provides attribute information Xd (first attribute information) for regular service use and also provide attribute information Xa (second attribute information) in association with use of an individual application and a second-type user group including a plurality of second-type users providing only the attribute information Xa in association with the use of the individual application. While the attribute information Xa is information (for example, information has a smaller number of information items than the attribute information Xd and includes, for example, application operation log information, position information acquired by the use of the application, and the like) having a lower level of detail than the attribute information Xd, the attribute information Xd is detailed information (for example, information including gender, age, hobbies, preferences, and the like) initially registered by the first-type user for regular service use. Therefore, as shown in FIG. 1, the attribute information DB 11 stores the attribute information Xd and attribute information Xa of the first-type users and the attribute information Xa of the second-type users. Further, in the present disclosure, the attribute information of various users (first-type and second-type users) is used during processing, and it goes without saying that only attribute information approved by the users is used.

The selection unit 12 is a functional unit that selects the attribute information Xd of the first-type user, which is a basis for inferring the attribute information Xd of a target second-type user (hereinafter, referred to as a “target user”), based on the attribute information Xd and attribute information Xa of the first-type users and the attribute information Xa of the second-type users according to predetermined conditions in the above-described environment. As an example, when the attribute information Xa of various first-type users is plotted in a multi-dimensional second data space (hereinafter, referred to as an “Xa space”) based on the attribute information Xa and the attribute information Xd of various first-type users is plotted in a multi-dimensional first data space (hereinafter, referred to as an “Xd space”) based on the attribute information Xd, the selection unit 12 sets a calculation formula for a distance in the Xa space such that, for the first-type users whose attribute information items Xa plotted in the Xa space is near in distance, the attribute information items Xa plotted in the Xa space are also near in distance. Then, the selection unit 12 selects one or more first-type users based on a “distance between the first-type users” and a “distance between the target user and the first-type user” in the Xa space calculated using the set calculation formula and selects the attribute information Xd of the selected first-type user as the basis for inferring the attribute information Xd of the target user. This series of processes will be described in detail below.

The generation unit 13 is a functional unit that infers the attribute information Xd of the target user based on the attribute information Xd of the first-type user selected by the selection unit 12 and generates a nudge for the target user based on an inferred value of the inferred attribute information Xd of the target user and the provided attribute information Xa of the target user. As an example, the generation unit 13 generates a learning model, in which the inferred value of the attribute information Xd and the attribute information Xa of various target users are used as explanatory variables and index values (in this embodiment, the number of times a message is opened) indicating the degrees of response of various target users to various nudges included in the messages delivered to the various target users by the delivery unit 14, which will be described below, are used as response variables, inputs the inferred value of the attribute information Xd and the attribute information Xa of the target user at the present time to the generated learning model to acquire the number of times each nudge is opened which is inferred for the target user at the present time, and uses the acquired number of times the message is opened for each nudge as an evaluation value for the nudge by the user. The generation unit 13 selects a nudge suitable for the target user at the present time, based on the evaluation value, and sets the selected nudge as the nudge for the target user at the present time. In this case, the nudge with the highest evaluation value is not necessarily selected as the nudge for the target user every time, but the nudge for the target user is selected with a “probability according to the evaluation value” for each nudge. The above-described series of processes will be described in detail below.

The delivery unit 14 is a functional unit that delivers the message including the nudge generated by the generation unit 13 to terminals 20 of various users (terminals 20A of the first-type users and terminals 20B of the second-type users). In this embodiment, push delivery is assumed as one form of the delivery, and the description focuses on a process of pushing the message including the nudge to the target user among the second-type users. In addition, the “delivery” here is not limited to the push delivery or message delivery. For example, the “delivery” may be a medium presented to the user when the user clicks on an advertisement on a website.

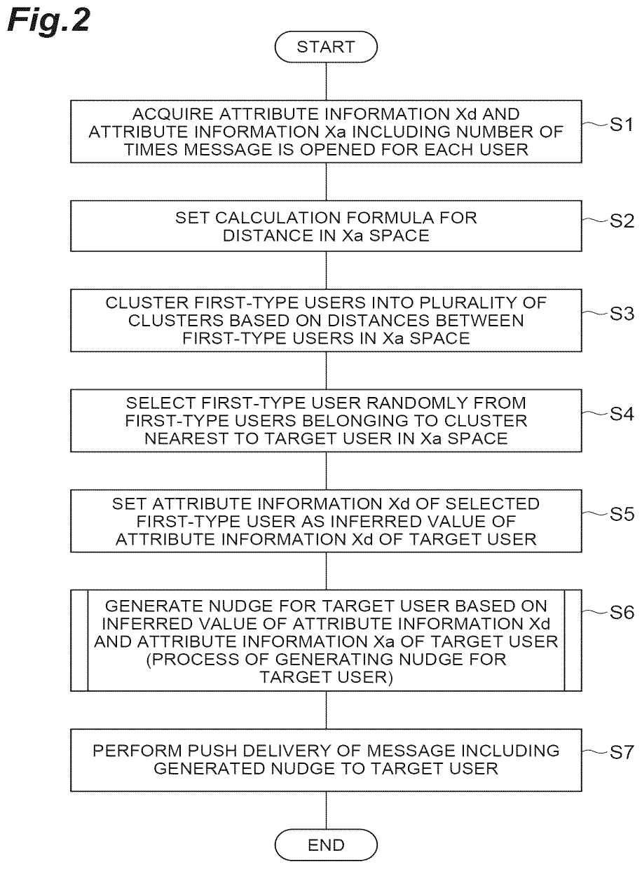

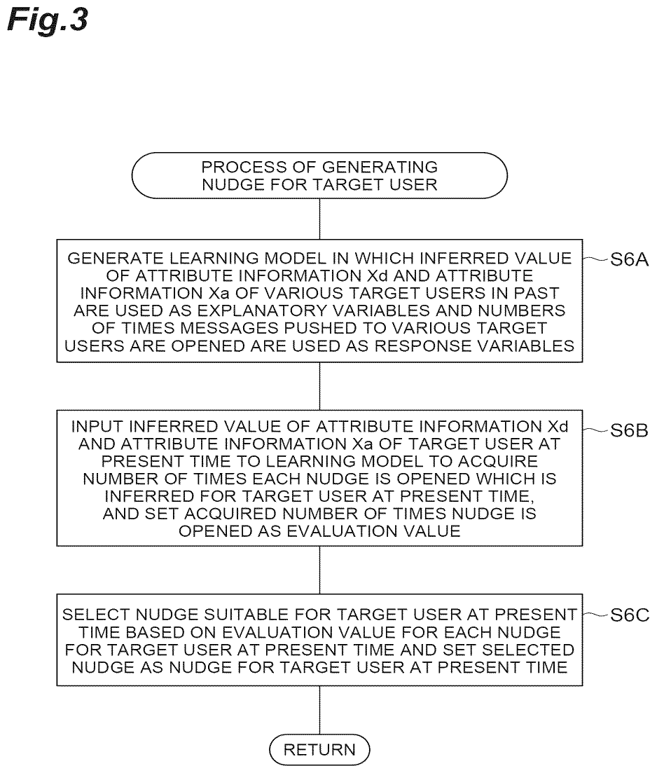

Next, the process executed by the information processing device 10 will be described with reference to flowcharts shown in FIGS. 2 and 3. In addition, it is assumed that the attribute information Xd and attribute information Xa of various first-type users and the attribute information Xa of various second-type users are acquired from outside in advance and stored in the attribute information DB 11 in advance. The process shown in FIG. 2 may be executed as a regular batch process at a predetermined time or may be executed in response to a start operation by an operator of the information processing device 10 as a trigger.

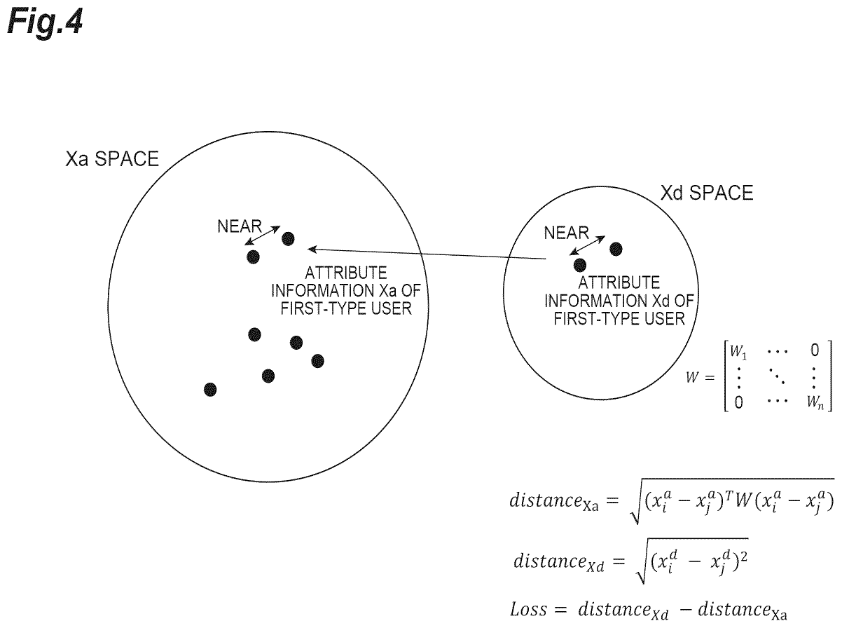

First, the selection unit 12 acquires the attribute information Xd and the attribute information Xa including the number of times the message is opened for each user from the attribute information DB 11 (Step S1 of FIG. 2). When the attribute information Xa of various first-type users is plotted in the Xa space and the attribute information Xd of various first-type users is plotted in the Xd space as shown in FIG. 4, the selection unit 12 randomly selects a first-type user i and a first-type user j and sets a calculation formula for a distance in the Xa space (the following Equation (1)) such that, for the first-type users whose attribute information items Xa plotted in the Xa space are near in distance, the attribute information items Xd plotted in the Xd space are also near in distance (Step S2).

$$\begin{matrix}[ Equation 1 ] & \\ {distance}_{Xa} = \sqrt{{( \text{?} - \text{?} )}^{T} W ( \text{?} - \text{?} )} & ( 1 )\end{matrix}$$

$$here , W = [ \begin{matrix}{W}_{1} & … & 0 \\ ⋮ & ⋱ & ⋮ \\ 0 & … & \text{?}\end{matrix} ]$$

$$\text{?} \text{indicates text missing or illegible when filed}$$

Specifically, the distance in the Xd space is calculated by Euclidean distance formula (2), and calculation formula (1) is set by learning a parameter W in calculation formula (1) such that, for the first-type users whose attribute information items Xa are near in distance, the attribute information items Xd are also near in distance.

$$\begin{matrix}[ Equation 2 ] & \\ {distance}_{Xd} = \sqrt{{( {x}_{i}^{d} - {x}_{j}^{d} )}^{2}} & ( 2 )\end{matrix}$$

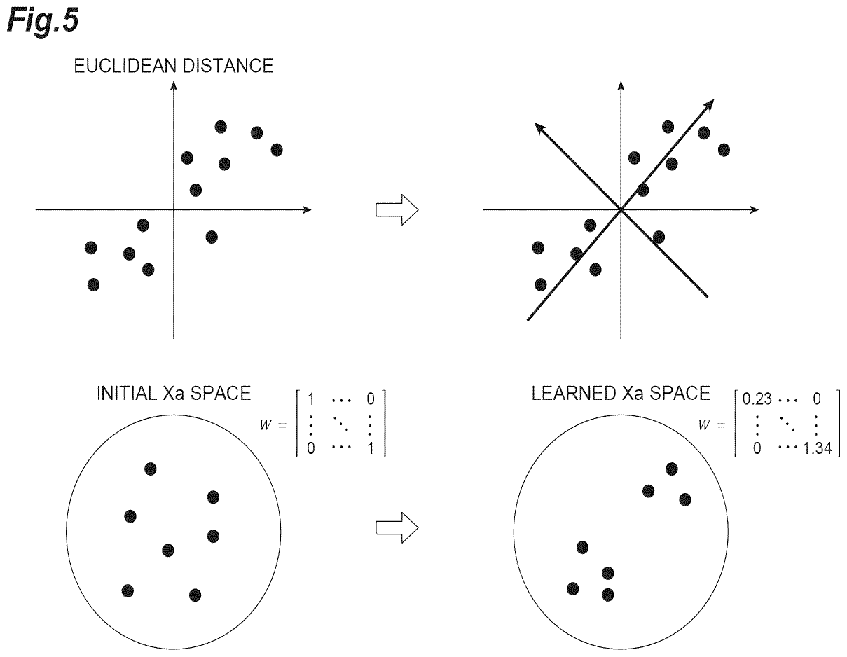

In calculation formula (1), the attribute information Xd is weighted by the parameter W such that the Xd space is reflected in the calculated distance. For example, as shown in FIG. 5, when the distance in the initial Xa space is represented by the Euclidean distance and the parameter W in calculation formula (1) is a unit matrix represented by the following Equation 3, the parameter W is adjusted, for example, as shown in the matrix of FIG. 5 by learning the parameter W.

$$\begin{matrix}[ Equation 3 ] & \\ W = [ \begin{matrix}1 & … & 0 \\ ⋮ & ⋱ & ⋮ \\ 0 & … & 1\end{matrix} ] & ( 3 )\end{matrix}$$

$$\begin{matrix}[ Equation 4 ] & \\ W = [ \begin{matrix}0.23 & … & 0 \\ ⋮ & ⋱ & ⋮ \\ 0 & … & 1.34\end{matrix} ] & ( 4 )\end{matrix}$$

As a specific method for learning the parameter W such that, for the first-type users whose attribute information items Xa are near in distance, the attribute information items Xd are also near in distance, the first-type user i and the first-type user j are randomly selected, and the parameter W is updated by a gradient method represented by the following Equation (6) in a direction in which a difference Loss between a distance distance_{xd} between the attribute information items Xd of these users and a distance distanceₓₐ between the attribute information items Xa of these users is reduced.

$$\begin{matrix}[ Equation 5 ] & \\ Loss = {distance}_{Xd} - {distance}_{Xa} & ( 5 )\end{matrix}$$

$$\begin{matrix}[ Equation 6 ] & \\ {W}^{′} = W + \frac{\partial Loss}{\partial W} & ( 6 )\end{matrix}$$

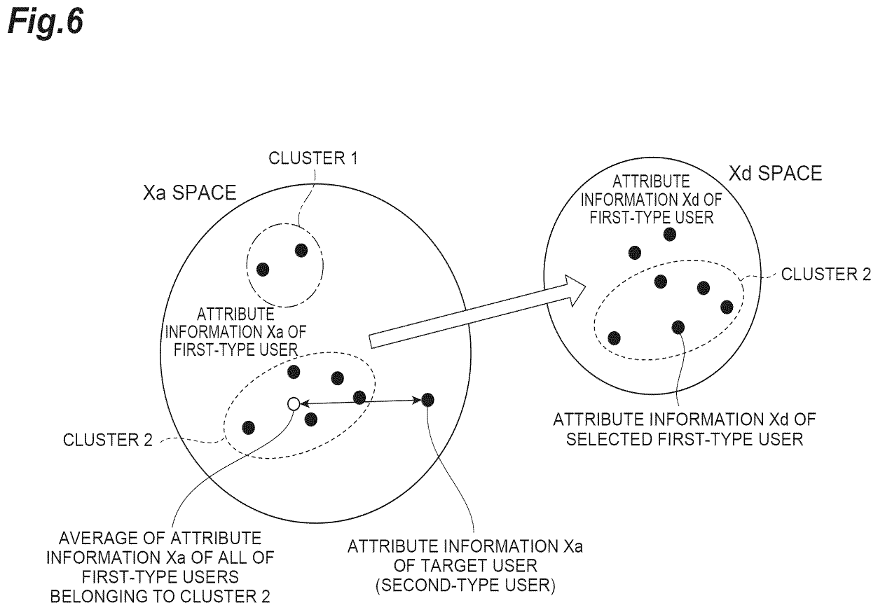

In the next Steps S3 and S4, the selection unit 12 selects one or more first-type users, based on the distance between the first-type users and the distance between the target user and the first-type user in the Xa space calculated using calculation formula (1) set in Step S2. Specifically, the selection unit 12 clusters the first-type users, who are near in distance, into clusters 1 and 2 based on the distance between the first-type users in the Xa space, for example, as shown in the Xa space of FIG. 6 (Step S3), and randomly selects one or more first-type users from the first-type users belonging to the cluster (here, cluster 2), which is nearest to the attribute information of the target user in the Xa space, of clusters 1 and 2 (Step S4). Here, the distance between the center of cluster 1 (the average of the attribute information Xa of all of the first-type users belonging to cluster 1) and the target user and the distance between the center of cluster 2 (the average of the attribute information Xa of all of the first-type users belonging to cluster 2) and the target user are calculated, and cluster 2 with the shorter of the calculated distances is referred to as the “nearest cluster”. Further, here, it is assumed that one first-type user is randomly selected from the first-type users belonging to cluster 2, and the attribute information Xd of the selected first-type user is shown in the Xd space of FIG. 6.

Then, the selection unit 12 infers the attribute information Xd of the target user based on the attribute information Xd of the selected first-type user. For example, the attribute information Xd of the selected first-type user shown in the Xd space of FIG. 6 is used as the inferred value of the attribute information Xd of the target user (Step S5). In addition to this aspect, for example, an average value of the attribute information Xd of a plurality of selected first-type users may be used as the inferred value of the attribute information Xd of the target user.

In the next Step S6, the generation unit 13 executes the process shown in FIG. 3 to generate a nudge for the target user based on the inferred value of the attribute information Xd of the target user and the attribute information Xa.

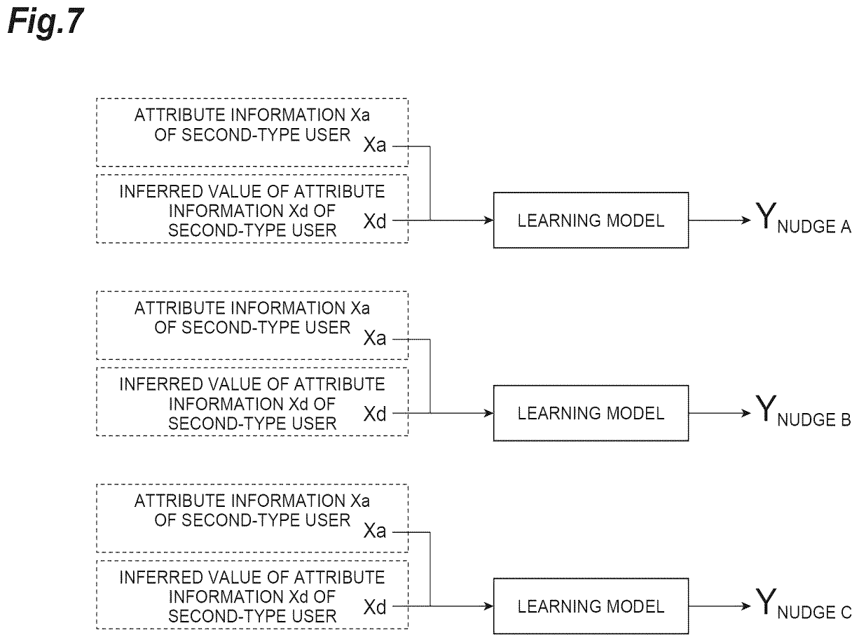

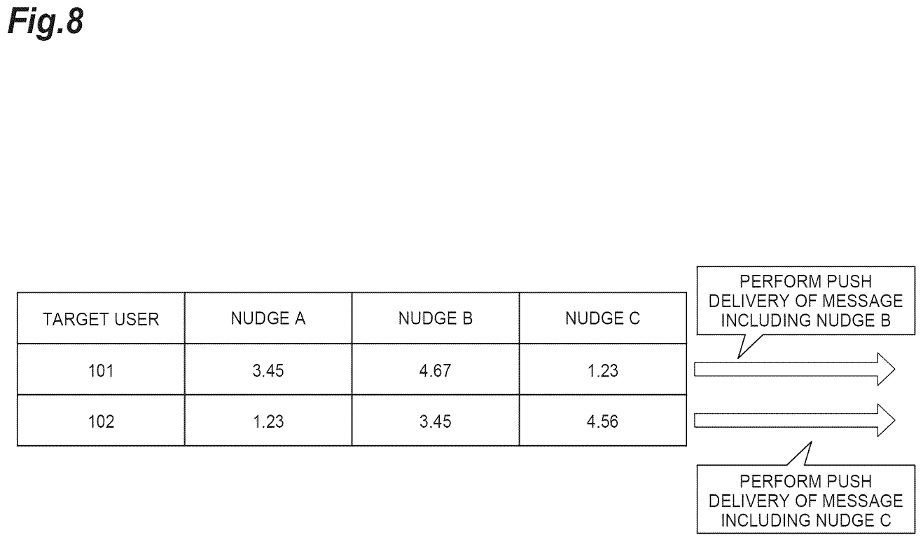

Specifically, as shown in FIG. 3, the generation unit 13 generates a learning model 13A using the inferred value of the attribute information Xd and the attribute information Xa of various target users in the past as the explanatory variables and the number of times the messages pushed to various target users are opened as the response variable (Step S6A). Then, as shown in FIG. 7, the generation unit 13 inputs the inferred value of the attribute information Xd and the attribute information Xa of the target user at the present time to the learning model 13A to acquire the number of times each nudge candidate (for example, nudges A, B, and C which are options for nudge distribution) is opened which is inferred for the target user at the present time, and sets the acquired number of times the message is opened as an evaluation value (Step S6B). Furthermore, the generation unit 13 selects a nudge suitable for the target user at the present time, based on the evaluation value for each nudge for the target user at the present time and sets the selected nudge as the nudge for the target user at the present time (Step S6C). At this time, the nudge for the target user is selected with a probability corresponding to the evaluation value for each nudge. Therefore, assuming that the evaluation values for each nudge shown in FIG. 8 are obtained, there is a high probability that the nudge B having the largest evaluation value will be selected as the nudge for a target user 101, and there is a high probability that the nudge C having the largest evaluation value will be selected as the nudge for a target user 102. In this way, the nudge for the target user at the present time is generated.

Returning to FIG. 2, in the next Step S7, the delivery unit 14 pushes a message including the nudge generated (selected) in Step S6 to the terminal 20B of the target user who is the second-type user.

The effects of the above-described embodiment will be described. The attribute information Xd selected by the selection unit 12 is used as the basis for inferring the attribute information Xd of the target user. Since the attribute information Xd as the basis is high-dimensional “detailed attribute information Xd”, it is possible to avoid inconvenience associated with the prediction of the high-dimensional “detailed attribute information Xd” from the low-dimensional “simple attribute information Xa” and to obtain appropriate basic information for inferring detailed attribute information Xd related to the target user whose detailed attribute information Xd has not been registered.

In addition, the selection unit 12 sets the calculation formula (the above-described Equation (1)) for the distance in the Xa space such that, for the first-type users who attribute information items Xa plotted in the Xa space are near in distance, the attribute information items Xd plotted in the Xd space are also near in distance, selects one or more first-type users using the set calculation formula, and selects the attribute information Xd of the selected first-type user as the basis for inferring the attribute information Xd of the target user. This process makes it possible to select the first-type user inferred to be near to the target user in the Xa space (for example, the first-type user inferred to be near to the target user in the Xd space) and to obtain the inferred value of the appropriate attribute information Xd of the target user based on the attribute information Xd of the selected first-type user.

More specifically, when selecting a first-type user, the selection unit 12 clusters a plurality of first-type users into a plurality of clusters based on the distance between the first-type users in the Xa space and selects a first-type user from the first-type users belonging to a cluster nearest to the target user in the Xa space among the plurality of clusters. Since a general-purpose technique called clustering is used in this way, it is possible to easily select the first-type user inferred to be near to the target user in the Xa space.

In addition, since the information processing device 10 further includes the generation unit 13 and the delivery unit 14, it is possible to generate a nudge for the target user, based on the inferred value of the appropriate attribute information Xd of the target user obtained by inference using appropriate basic information and the attribute information Xa, and to push a message including the generated nudge to the target user.

More specifically, the generation unit 13 executes the “process of generating the nudge for the target users” shown in FIG. 3, which makes it possible to more appropriately generate (select) the nudge for the target user at the present time, using the learning model in which the inferred value of the attribute information Xd and the attribute information Xa of various target users are used as the explanatory variables and the index value (the number of times the message is opened) indicating the degree of response of various target users is used as the response variable.

### Modification Example 1

In general, there is a tendency that, as the number of times a message including a nudge is delivered is larger, the degree of response of the user to the message is smaller (that is, the number of times the user opens the message is smaller). Therefore, Modification Example 1 in which weighting is performed in the prediction of the number of times the message is opened (index value) will be described.

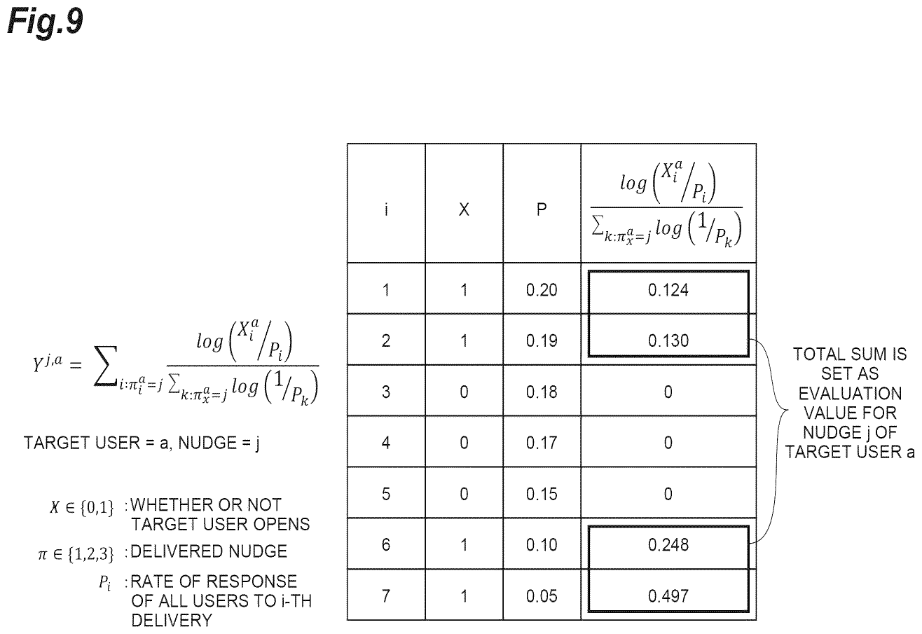

Specifically, an example may be described in which the number of users is narrowed down to only the users who have opened the messages and a higher weight is assigned to the user who has opened the message even though the open rate of all users is low. For example, as shown in FIG. 9, the generation unit 13 derives the number of times the message is opened Y^{j,a} after a nudge j for a user a is weighted, using the following Equation (7), to adjust the number of times the message is opened Y^{j,a} such that it is larger as the number of times the message including the nudge is delivered is larger.

$$\begin{matrix}[ Equation 7 ] & \\ \text{?} = \text{?} \frac{log ( \text{?} / \text{?} )}{\text{?} log ( 1 / {P}_{k} )} & ( 7 )\end{matrix}$$

$$Target user = a , Nudge = j$$

$$\begin{matrix}X ∈ \{ 0 , 1 \} & ⋮ & Whether or not target user opens \\ π ∈ \{ 1 , 2 , 3 \} & ⋮ & Delivered nudge \\ \text{?} & ⋮ & Rate of response of all \\ & & users to i - th delivery\end{matrix}$$

$$\text{?} \text{indicates text missing or illegible when filed}$$

In addition, the following Equation 8 in the above-described Equation (7) means that, when the user a opens the nudge j, the number of times the user has received the nudge is k.

$$k : {π}_{x}^{a} = j \qquad [ Equation 8 ]$$

That is, the logarithm of the reciprocal of the total number of times the message is opened “log (1/Pₖ)” is calculated only for the number of times the message is received when the user a opens the nudge j (the first, second, sixth, and seventh times in the table of FIG. 9), and k is used to sum up all of the open rates.

Further, the following Equation 9n in the above-described Equation (7) means that the i-th reception of the user a is the nudge j.

$$u : {π}_{i}^{a} = j \qquad [ Equation 9 ]$$

That is, i is used to sum up all of the evaluation values (the evaluation values for the first, second, sixth, and seventh times in the table of FIG. 9) when the user a opens the nudge j.

With the use of the above-described Equation (7), as shown in the table of FIG. 9, a rate of response P of all users to the delivery decreases as the number of times the message is delivered increases. For the number of times the user opens the message (the first, second, sixth, and seventh times), the following Equation 10 is adjusted such that the rate of response P is larger as the number of times the message is delivered is larger, and the number of times the message is opened Y^{j,a} after the nudge j for the user a is weighted (that is, the sum of the evaluation values for the first, second, sixth, and seventh times) is calculated.

$$\frac{log ( {X}_{i}^{a} / {P}_{i} )}{\text{?} log ( 1 / {P}_{k} )} \qquad [ Equation 10 ]$$

$$\text{?} \text{indicates text missing or illegible when filed}$$

Therefore, the number of users is narrowed down to only the users who have opened the messages, and it is possible to assign a higher weight to the user who has opened the message even though the open rate of all users is low and thus to obtain a more appropriate evaluation value.

### Modification Example 2

Next, Modification Example 2 in which a prediction result (evaluation value) of the number of times the message is opened is fed back to the setting of the distance calculation formula in the Xa space will be described. Here, the selection unit 12 sets a calculation formula for a distance in the Xa space, based on the degree of importance of each explanatory variable in the prediction of the response variable which has been obtained by the learning model generation process of the generation unit 13.

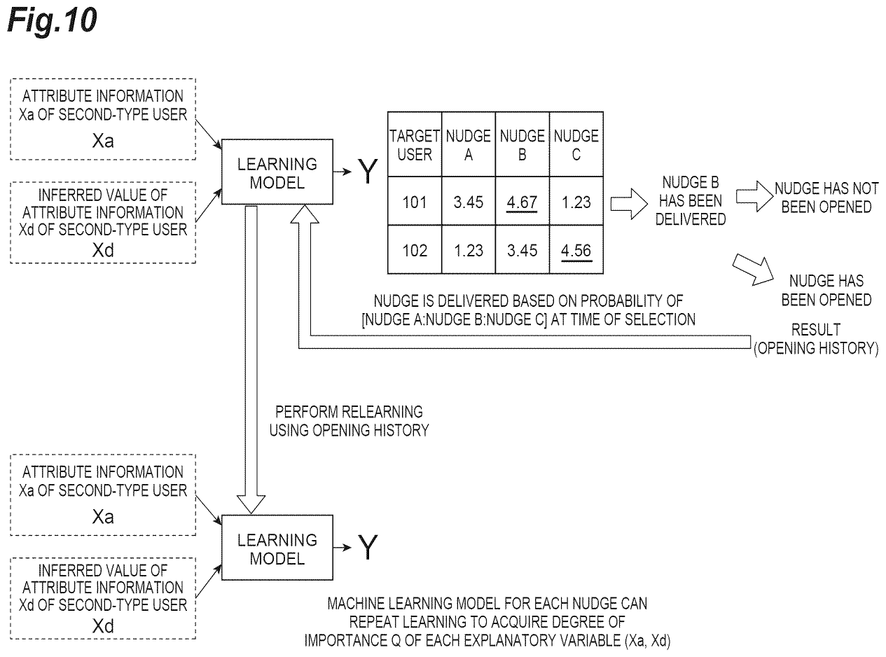

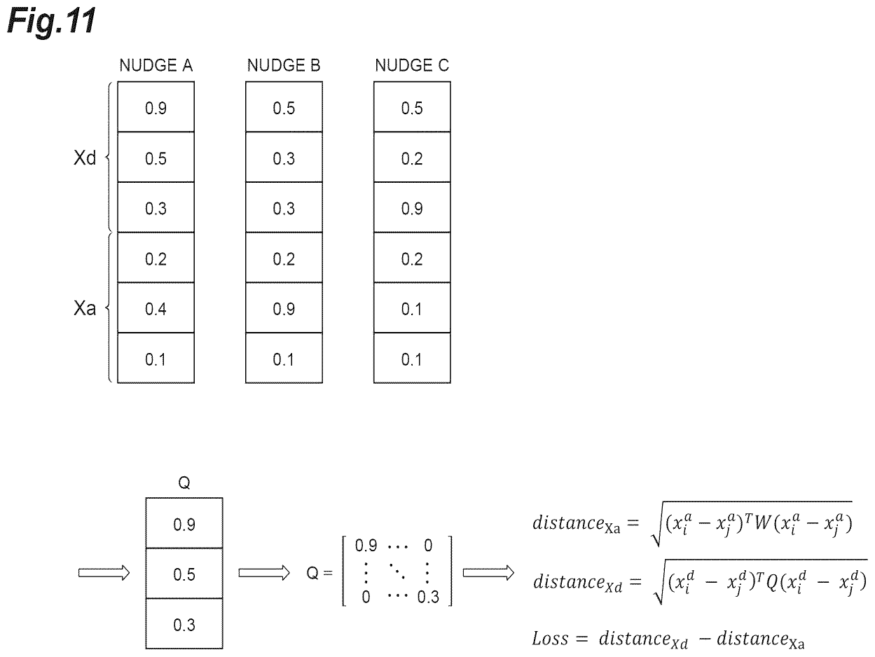

Specifically, as shown in FIG. 10, the generation unit 13 repeats the generation of a learning model (for example, a learning process), in which the inferred value of the attribute information Xd and the attribute information Xa of the target user are used as the explanatory variables and a history of the opening of the nudge is used as the response variable, to acquire the degree of importance Q of each explanatory variable (attribute information items Xa and Xd) in a machine learning model for each nudge. Then, as shown in FIG. 11, the selection unit 12 converts the degree of importance Q of the attribute information Xd acquired in the learning process into a matrix and substitutes the matrix into the calculation formula for the distance distance_{Xd} in the Xd space. The calculation formula for the distance distance_{Xd} is used to optimize the parameter W in the calculation formula for the distance distance_{Xa} so as to minimize the error Loss with respect to the distance distance_{Xa} in the Xa space.

Therefore, the degree of importance Q of the attribute information Xd fed back from the learning process is used to optimize the parameter W in the calculation formula for the distance distance_{Xa}.

In the optimization of the parameter W in the calculation formula for the distance distance_{Xa}, appropriate optimization is performed according to the degree of importance Q of each attribute information item Xd. As a result, the selection unit 12 can select a more appropriate first-type user and can obtain the inferred value of the more appropriate attribute information Xd of the target user, based on the attribute information Xd of the selected first-type user.

Further, in addition to the above-described Modification Examples 1 and 2, the method of selecting the first-type user in Steps S1 to S4 of FIG. 2 may be achieved by an algorithm other than the above-described method. Furthermore, the attribute information items Xa and Xd are not limited to the above-described attribute information.

The gist of the present disclosure lies in the following [1] to [5].

[1] An information processing device including:
a selection unit that, in an environment in which there are a first-type user group including a plurality of first-type users, who provide first attribute information for regular service use and provide second attribute information having a lower level of detail than the first attribute information in association with use of an individual application, and a second-type user group including a plurality of second-type users providing only the second attribute information, selects the first attribute information of the first-type user, which is a basis for inferring the first attribute information of a target user who is a target second-type user, according to a predetermined condition based on the first attribute information provided from the first-type user and the second attribute information provided from the first-type user and the second-type user.

[2] The information processing device according to [1],
wherein the selection unit sets a calculation formula for a distance in a multi-dimensional second data space based on the second attribute information such that the first-type users near to each other in distance in the second data space are also near to each other in distance in a multi-dimensional first data space based on the first attribute information, selects one or more first-type users, based on a distance between the first-type users and a distance between the target user and the first-type user in the second data space calculated using the set calculation formula, and selects the first attribute information of the selected first-type user as the basis for inferring the first attribute information of the target user.

[3] The information processing device according to [2],
wherein, when selecting the one or more first-type users, the selection unit clusters the plurality of first-type users into a plurality of clusters, based on the distances between the first-type users in the second data space, and selects the one or more first-type users from the first-type users belonging to a cluster nearest to the target user in the second data space among the plurality of clusters, based on a predetermined method.

[4] The information processing device according to [2] or [3], further comprising:
a generation unit inferring the first attribute information of the target user, based on the first attribute information of the first-type user selected by the selection unit, and generating a nudge for the target user, based on the inferred first attribute information of the target user and the provided second attribute information of the target user; and
a delivery unit delivering a message including the nudge generated by the generation unit to the target user.

[5] The information processing device according to [4],
wherein the generation unit generates a learning model in which the first attribute information and the second attribute information of various target users are used as explanatory variables and index values indicating degrees of response of the various target users to various nudges included in the messages delivered to the various target users by the delivery unit are used as response variables, inputs the first attribute information and the second attribute information of the target user at a present time to the generated learning model to acquire the index value for each nudge inferred for the target user at the present time, selects a nudge suitable for the target user at the present time based on the acquired index value for each nudge for the target user at the present time, and sets the selected nudge as a nudge for the target user at the present time.

[6] The information processing device according to [5],
wherein, when calculating the index value indicating the degree of response of the target user, the generation unit adjusts the index value for the same nudge such that the index value is larger as the number of times the message including the nudge is delivered is larger and calculates the index value.

[7] The information processing device according to [5] or [6],
wherein the selection unit sets the calculation formula for the distance in the second data space, based on a degree of importance of the first attribute information used as the explanatory variable among the degrees of importance of each of the explanatory variables in prediction of the response variable obtained by a process of generating the learning model by the generation unit.

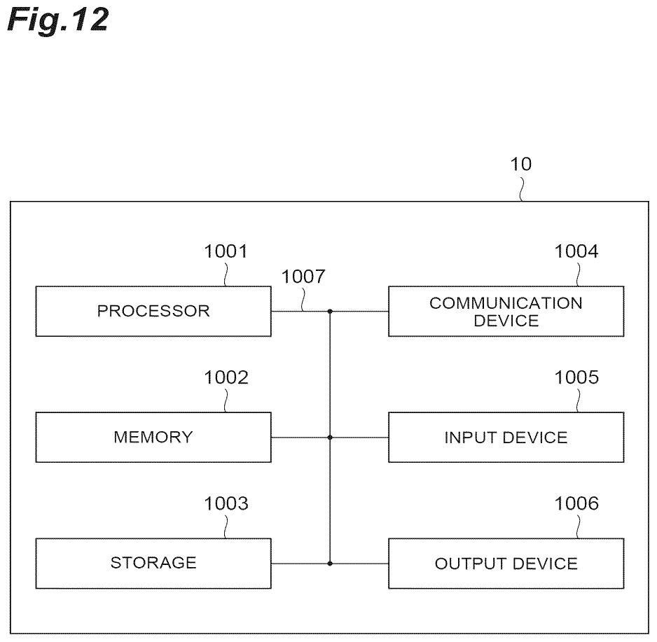

### (Description of Terms, Description of Hardware Configuration (FIG. 12), and the Like)

In addition, the block diagrams used to describe the embodiment show functional blocks. These functional blocks (configuration units) are implemented by any combination of at least one of hardware and software. Further, a method for implementing each functional block is not particularly limited. That is, each functional block may be implemented by one device physically or logically coupled or by connecting two or more devices physically or logically separated from each other directly or indirectly (for example, wirelessly or in a wired manner) and using the plurality of devices. The functional blocks may be implemented by combining software with the one device or the plurality of devices.

The functions include judgement, decision, determination, computation, calculation, processing, derivation, investigation, search, confirmation, reception, transmission, output, access, resolution, selection, choice, establishment, comparison, assumption, expectation, consideration, broadcasting, notifying, communicating, forwarding, configuring, reconfiguring, allocating, mapping, assigning, and the like. However, the functions are not limited thereto. For example, a functional block (configuration unit) having a transmission function is referred to as a transmitting unit or a transmitter. In any case, as described above, a method for implementing the functional block is not particularly limited.

For example, the information processing device and the like according to the embodiment of the present disclosure may function as a computer executing the processes of the present disclosure. FIG. 12 is a diagram showing an example of a hardware configuration of the information processing device 10 according to the embodiment of the present disclosure. The information processing device 10 may be physically configured as a computer device including, for example, a processor 1001, a memory 1002, a storage 1003, the communication device 1004, an input device 1005, an output device 1006, and a bus 1007.

Furthermore, in the following description, the term “device” can be replaced with, for example, a circuit, an apparatus, or a unit. The hardware configuration of the information processing device 10 may be configured to include one or more of the devices shown in the drawings or may be configured not to include some of the devices.

Each of the functions of the information processing device 10 is implemented by loading predetermined software (program) onto hardware, such as the processor 1001 and the memory 1002, and by causing the processor 1001 to perform an operation to control communication by the communication device 1004 or to control at least one of the reading and writing of data from and to the memory 1002 and the storage 1003.

For example, the processor 1001 operates an operating system to control the entire computer. The processor 1001 may be configured by a central processing unit (CPU) including, for example, an interface with peripheral devices, a control device, an arithmetic device, and a register.

In addition, the processor 1001 reads, for example, a program (program code), a software module, or data from at least one of the storage 1003 and the communication device 1004 to the memory 1002 and executes various processes according to the read program, software module, or data. As the program, a program that causes the computer to execute at least some of the operations described in the above-mentioned embodiment is used. In the above description, the various processes are executed by one processor 1001. However, the various processes may be executed at the same time or sequentially by two or more processors 1001. The processor 1001 may be implemented by one or more chips. In addition, the program may be transmitted from the network through a telecommunication line.

The memory 1002 is a computer-readable recording medium and may be configured by, for example, at least one of a read only memory (ROM), an erasable programmable ROM (EPROM), an electrically erasable programmable ROM (EEPROM), and a random access memory (RAM). The memory 1002 may be referred to as, for example, a register, a cache, or a main memory (main storage device). The memory 1002 can store, for example, an executable program (program code) or a software module for executing a wireless communication method according to the embodiment of the present disclosure.

The storage 1003 is a computer-readable recording medium and may be configured by, for example, at least one of an optical disc, such as a compact disc ROM (CD-ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a Floppy (registered trademark) disk, and a magnetic strip. The storage 1003 may also be referred to as an auxiliary storage device. The above-described storage medium may be, for example, a database, a server, or other suitable media including at least one of the memory 1002 and the storage 1003.

The communication device 1004 is hardware (transmitting and receiving device) for communication between computers via at least one of a wired network and a wireless network and is referred to as, for example, a network device, a network controller, a network card, a communication module, or the like. The communication device 1004 may include a high-frequency switch, a duplexer, a filter, a frequency synthesizer, and the like in order to implement at least one of frequency division duplex (FDD) and time division duplex (TDD).

The input device 1005 is an input device (for example, a keyboard, a mouse, a microphone, a switch, a button, a sensor, or the like) receiving an input from the outside. The output device 1006 is an output device (for example, a display, a speaker, an LED lamp, or the like) performing output to the outside. The input device 1005 and the output device 1006 may be integrated (for example, into a touch panel).

Further, the devices, such as the processor 1001 and the memory 1002, are connected to each other by the bus 1007 for information communication. The bus 1007 may be configured using a single bus or may be configured using different buses between the devices.

Furthermore, the information processing device 10 may include hardware, such as a microprocessor, a digital signal processor (DSP), an application specific integrated circuit (ASIC), a programmable logic device (PLD), and a field programmable gate array (FPGA), and some or all of the functional blocks may be implemented by the hardware. For example, the processor 1001 may be implemented using at least one of the hardware components.

The notification of information is not limited to the aspects/embodiments described in the present disclosure and may be performed by other methods. For example, the notification of information may be performed by physical layer signaling (for example, downlink control information (DCI) or uplink control information (UCI)), upper layer signaling (for example, radio resource control (RRC) signaling, medium access control (MAC) signaling, or broadcast information (a master information block (MIB) or a system information block (SIB)), other signals, or a combination thereof. In addition, the RRC signaling may also be referred to as an RRC message. For example, the RRC signaling may be an RRC connection setup message, an RRC connection reconfiguration message, or the like.

Each of the aspects/embodiments described in the present disclosure may be applied to at least one of systems using Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG)(xG(x is, for example, an integer or a decimal number)), Future Radio Access (FRA), New Radio (NR), New Radio Access (NX), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), and other appropriate systems and next-generation systems expanded, modified, created, or defined based on these systems. In addition, a plurality of systems may be combined (for example, a combination of at least one of LTE and LTE-A and 5G or the like) and then applied.

The order of the processing procedures, the sequence, the flowchart, and the like in each of the aspects/embodiments described in the present disclosure may be interchanged as long as there is no contradiction. For example, in the method described in the present disclosure, elements of various steps are presented using an exemplary order, and the present disclosure is not limited to the presented specific order.

The input or output information and the like may be stored in a specific location (for example, a memory) or may be managed using a management table. For example, the input or output information and the like may be overwritten, updated, or edited. For example, the output information and the like may be deleted. The input information and the like may be transmitted to other devices.

The determination may be performed with a value (0 or 1) represented by 1 bit, may be performed by a true or false value (Boolean: true or false), or may be performed by comparison with a numerical value (for example, comparison with a predetermined value).

The aspects/embodiments described in the present disclosure may be singly used, may be combined for use, or may be switched and used according to execution. In addition, the notification of predetermined information (for example, the notification of “being X”) is not limited to being performed explicitly and may be performed implicitly (for example, the notification of the predetermined information is not performed).

The present disclosure has been described in detail above, but it should be apparent to those skilled in the art that the present disclosure is not limited to the embodiments described in the present disclosure. The present disclosure can be embodied as corrected and changed aspects without departing from the gist and scope of the present disclosure defined by the claims. Therefore, the description of the present disclosure has been made for exemplary description and is not intended to imply any limitations on the present disclosure.

Regardless of whether software is referred to as software, firmware, middleware, a microcode, or a hardware description language or is referred to as other names, the software needs be interpreted broadly to mean a command, a command set, a code, a code segment, a program code, a program, a sub-program, a software module, an application, a software application, a software package, a routine, a subroutine, an object, an executable file, an execution thread, a procedure, a function, and the like.

In addition, software, a command, information, and the like may be transmitted or received through a transmission medium. For example, when software is transmitted from a website, a server, or other remote sources by at least one of a wired technology (a coaxial cable, an optical fiber cable, a twisted pair, a digital subscriber line (DSL), or the like) and a wireless technology (infrared rays, microwaves, or the like), at least one of the wired technology and the wireless technology is included in the definition of the transmission medium.

The information, the signals, and the like described in the present disclosure may be represented by any of various different techniques. For example, the data, the order, the command, the information, the signal, the bit, the symbol, the chip, and the like mentioned throughout the above description may be represented by a voltage, a current, an electromagnetic wave, a magnetic field or a magnetic particle, an optical field or a photon, or any combination thereof.

In addition, the terms described in the present disclosure and the terms necessary to understand the present disclosure may be replaced with terms having the same or similar meanings. For example, at least one of a channel and a symbol may be a signal (signaling). Further, the signal may be a message. Furthermore, a component carrier (CC) may be referred to as a carrier frequency, a cell, a frequency carrier, or the like.

The terms “system” and “network” used in the present disclosure are compatibly used.

Furthermore, the information, the parameters, and the like described in the present disclosure may be represented by an absolute value, may be represented by a relative value from a predetermined value, or may be represented by another corresponding information item. For example, the radio resources may be indicated by an index.

The names used for the above-described parameters are not limited in any respect. Further, numerical expressions and the like using the parameters may be different from the numerical expressions described explicitly in the present disclosure. Various channels (for example, PUCCH, PDCCH, and the like) and information elements can be identified by any suitable names. Therefore, the various names assigned to the various channels and information elements are not intended to be limiting in any way.

In some cases, the terms “determining” and “deciding” used in the present disclosure include a wide variety of operations. The “determining” and the “deciding” can include cases where performing, for example, judging, calculating, computing, processing, deriving, investigating, looking up, search, or inquiry (for example, looking up in a table, a database, or other data structures), and ascertaining is considered to perform “determining” and “deciding”. In addition, the “determining” and the “deciding” can include, for example, cases where performing receiving (for example, receiving information), transmitting (for example, transmitting information), input, output, and accessing (for example, accessing data in a memory) is considered to perform “determining” and “deciding”. Further, the “determining” and the “deciding” can include cases where performing resolving, selecting, choosing, establishing, comparing, and the like is considered to perform “determining” and “deciding”. That is, the “determining” and the “deciding” can include a case where any operation is considered to perform “determining” and “deciding”. Furthermore, the “determining (deciding)” may be replaced with “assuming”, “expecting”, “considering”, or the like.

The term “based on” used in the present disclosure does not mean “based on only” unless otherwise stated. In other words, the term “based on” means both “based on only” and “based on at least”.

Any reference to elements using names “first”, “second”, and the like used in the present disclosure does not generally limit the quantity or order of those elements. The names can be used in the present disclosure as methods used to conveniently distinguish two or more elements from each other. Therefore, the reference to the first and second elements does not mean that only two elements can be employed or that the first element needs to precede the second element in any form.

In the present disclosure, when the terms “include” and “including” and modifications thereof are used, the terms are intended to be inclusive like the term “comprising”. Further, the term “or” used in the present disclosure is not intended to be an exclusive OR.

In the present disclosure, for example, when the articles, such as “a”, “an”, and “the”, in English are added in translation, the present disclosure may include that the nouns following these articles are plural.

In the present disclosure, the term “A and B are different” may mean that “A and B are different from each other”. The term may also mean that “A and B are different from C”. The terms “separated”, “coupled”, and the like may be interpreted in the same way as “different”.

### REFERENCE SIGNS LIST

10: information processing device, 11: attribute information DB, 12: selection unit, 13: generation unit, 13A: learning model, 14: delivery unit, 20, 20A, 20B: terminal, 1001: processor, 1002: memory, 1003: storage, 1004: communication device, 1005: input device, 1006: output device, 1007: bus.

1. An information processing device comprising:
a selection unit that, in an environment in which there are a first-type user group including a plurality of first-type users, who provide first attribute information for regular service use and provide second attribute information having a lower level of detail than the first attribute information in association with use of an individual application, and a second-type user group including a plurality of second-type users providing only the second attribute information, selects the first attribute information of the first-type user, which is a basis for inferring the first attribute information of a target user who is a target second-type user, according to a predetermined condition based on the first attribute information provided from the first-type user and the second attribute information provided from the first-type user and the second-type user.

2. The information processing device according to claim 1,
wherein the selection unit sets a calculation formula for a distance in a multi-dimensional second data space based on the second attribute information such that the first-type users near to each other in distance in the second data space are also near to each other in distance in a multi-dimensional first data space based on the first attribute information, selects one or more first-type users, based on a distance between the first-type users and a distance between the target user and the first-type user in the second data space calculated using the set calculation formula, and selects the first attribute information of the selected first-type user as the basis for inferring the first attribute information of the target user.

3. The information processing device according to claim 2,
wherein, when selecting the one or more first-type users, the selection unit clusters the plurality of first-type users into a plurality of clusters, based on the distances between the first-type users in the second data space, and selects the one or more first-type users from the first-type users belonging to a cluster nearest to the target user in the second data space among the plurality of clusters, based on a predetermined method.

4. The information processing device according to claim 2, further comprising:
a generation unit inferring the first attribute information of the target user, based on the first attribute information of the first-type user selected by the selection unit, and generating a nudge for the target user, based on the inferred first attribute information of the target user and the provided second attribute information of the target user; and
a delivery unit delivering a message including the nudge generated by the generation unit to the target user.

5. The information processing device according to claim 4,
wherein the generation unit generates a learning model in which the first attribute information and the second attribute information of various target users are used as explanatory variables and index values indicating degrees of response of the various target users to various nudges included in the messages delivered to the various target users by the delivery unit are used as response variables, inputs the first attribute information and the second attribute information of the target user at a present time to the generated learning model to acquire the index value for each nudge inferred for the target user at the present time, selects a nudge suitable for the target user at the present time based on the acquired index value for each nudge for the target user at the present time, and sets the selected nudge as a nudge for the target user at the present time.

6. The information processing device according to claim 5,
wherein, when calculating the index value indicating the degree of response of the target user, the generation unit adjusts the index value for the same nudge such that the index value is larger as the number of times the message including the nudge is delivered is larger and calculates the index value.

7. The information processing device according to claim 5,
wherein the selection unit sets the calculation formula for the distance in the second data space, based on a degree of importance of the first attribute information used as the explanatory variable among the degrees of importance of each of the explanatory variables in prediction of the response variable obtained by a process of generating the learning model by the generation unit.
